(19) United States
(12) Patent Application Publication
(10) Pub. No.: US 2013/0210162 A1
(43) Pub. Date: Aug. 15, 2013

(54) ATMOSPHERIC PRESSURE LASER-INDUCED ACOUSTIC DESORPTION CHEMICAL IONIZATION FOR GLOBAL HYDROCARBON ANALYSIS

(71) Applicant: Florida State University Research Foundation, Inc., (US)

(72) Inventors: LEONARD NYADONG, Tallahassee, FL (US); RYAN P. RODGERS, Tallahassee, FL (US); CHRISTOPHER L. HENDRICKSON, Tallahassee, FL (US); ALAN G. MARSHALL, Tallahassee, FL (US)

(73) Assignee: FLORIDA STATE UNIVERSITY RESEARCH FOUNDATION, INC., Tallahasse, FL (US)

(21) Appl. No.: 13/763,159

(22) Filed: Feb. 8, 2013

Related U.S. Application Data
(60) Provisional application No. 61/597,378, filed on Feb. 10, 2012.
(60) Provisional application No. 61/600,429, filed on Feb. 17, 2012.

(51) Int. Cl. G01N 27/62

(52) U.S. Cl. CPC G01N 27/62
USPC 436/173; 422/83

(57) ABSTRACT

Systems, devices, and methods, operational at atmospheric pressure, involving a conical member having an outlet positioned relative to an inlet of a mass spectrometer inlet capillary; a tungsten electrode positioned between the conical member and the inlet of the mass spectrometer inlet capillary; a foil membrane disposed within the conical member, the foil membrane having a first surface, and a second surface opposed to the first surface; a laser directing laser pulses at the second surface of the foil membrane to create a shockwave to vaporize one or more analytes deposited on the first surface; a reagent gas inlet stream positioned relative to the foil membrane to pass a reagent gas across the foil member to transport vaporized analytes: away from the foil membrane, through the outlet of the conical member, through a corona discharge generated by the tungsten electrode, and into the inlet capillary of a mass spectrometer.

### CROSS-REFERENCES TO RELATED APPLICATIONS

This application claims benefit under 35 U.S.C. §119(e) to U.S. Provisional Patent Application Ser. No. 61/597,378 filed on Feb. 10, 2012, and to U.S. Provisional Patent Application Ser. No. 61/600,429 filed on Feb. 17, 2012, which are hereby incorporated by reference in their entireties.

### STATEMENT REGARDING FEDERALLY SPONSORED RESEARCH OR DEVELOPMENT

This invention was made with government support under contract number DMR-06-54118 awarded by the National Science Foundation. The government has certain rights in the invention.

### BACKGROUND OF THE INVENTION

1. Field of the Invention

The invention relates generally to atmospheric pressure ionization (API) techniques, and more specifically to atmospheric pressure laser-induced acoustic desorption chemical ionization.

2. Description of the Related Art

The introduction of atmospheric pressure ionization (API) techniques notably atmospheric pressure chemical ionization (APCI), electrospray ionization (ESI), atmospheric pressure matrix assisted laser desorption ionization (AP/MALDI), and atmospheric pressure photoionization (APPI) began a new era in mass spectrometry that marked a pivotal milestone in the evolution of the present day mass spectrometer. API sources are characterized by operation at atmospheric pressure outside the vacuum system of the mass spectrometer. Ion source operation in vacuum requires that gaseous or liquid samples be introduced by gas chromatography (GC) or a specially designed inlet system, whereas solid samples must be introduced by use of a direct insertion probe requiring a vacuum lock system. A direct insertion probe can result in vacuum failure and/or contamination of the source if too much sample is introduced. API techniques overcome these limitations, making them desirable because of their ease of implementation, enabling increased throughput and sensitivity, and extending the range of samples accessible by mass spectrometry analysis.

Saturated hydrocarbons, the major fraction of most petroleum crude oils, present a challenge for API mass spectrometry analysis because of their lack of easily ionizable functional groups and tendency to fragment. Therefore, they have most commonly been analyzed by use of vacuum techniques such as electron ionization (EI), field ionization (FI) and field desorption (FD). However, the high energy electrons (70 eV) used in EI often result in exhaustive fragmentation of the molecular ion. The use of supersonic molecular beams to vibrationally cool the gas phase analytes prior to EI can reduce (but not eliminate) fragmentation, which can be further decreased by use of lower energy electrons (18 eV). Nevertheless, FI and FD are however, the main soft ionization techniques currently used for saturated hydrocarbon analysis. For FI/FD, the thermal vaporization of a sample can also cause fragmentation of the high boiling paraffins, especially branched paraffins, which can result in almost complete dissociation of the molecular ion. Direct laser desorption/ionization (LDI) techniques with various transition metal reagent cations (e.g., Ag⁺, Cu⁺, Mn⁺ and Cr⁺) have also shown promise for the analysis of saturated hydrocarbons. However, LDI methods often discriminate against higher-mass species that can either undergo dissociation to generate abundant low-mass fragment ions or aggregate with other species in the desorption plume. Atmospheric pressure ionization techniques recently shown to generate saturated hydrocarbon molecular ion and/or hydride abstraction signals include direct analysis in real time (DART, under conditions that produce abundant O₂⁺. in the background mass spectrum) and a helium plasma ionization source (HPIS), both of which require thermal vaporization of the sample. However, those techniques exhibit low and high mass discrimination and the high thermal energy required to vaporize the high boiling alkanes readily induces dissociation, especially for branched alkanes. Desorption electrospray ionization in the presence of an electric discharge has also been used for the analysis of saturated hydrocarbons. This method results in a complex mass spectrum in which each saturated hydrocarbon species generates multiple alcohol and hydroxyketone oxidation products and no unoxygenated hydrocarbon signal.

Laser-induced acoustic desorption (LIAD) is a technique for the vaporization of analytes from a thin metal foil by use of acoustic waves generated in the foil following laser irradiation from the side opposite the deposited sample. Gas-phase neutrals are desorbed by this technique with little or no internal energy deposition. Ionization can thus be tailored to generate intact analyte ions with little or no fragmentation. LIAD has been coupled to chemical ionization in vacuum by use of a complex series of reactions to generate a cyclopentadienyl cobalt radical cation, for efficient desorption/ionization of saturated hydrocarbons with little or no fragmentation, and no bias between low-mass and high mass species. The technique yields molecular weight distributions similar to those from gel permeation chromatography (GPC) for low mass polyethylene. A ligated water cluster of Mn⁺ (namely, ClMn(H₂O)⁺) has also been coupled with LIAD as a chemical ionization reagent in vacuum for the analysis of the saturated hydrocarbons in base oil.

### BRIEF SUMMARY OF THE INVENTION

Various embodiments of the present invention provide atmospheric pressure laser-induced acoustic desorption chemical ionization (AP/LIAD-CI) with O₂ carrier/reagent gas as a powerful new approach for the analysis of saturated hydrocarbon mixtures. In addition to O₂, N₂, He or any suitable gas can be used as a carrier/reagent gas depending on the application. According to various embodiments AP/LIAD can be used for non-thermal sample vaporization with subsequent chemical ionization to generate abundant ion signals for straight-chain, branched and cycloalkanes with minimal or no fragmentation. [M-H]⁺ is the dominant species for straight-chain and branched alkanes. For cycloalkanes, M⁺. species dominate the mass spectrum at lower capillary temperature (<100° C.) and [M-H]⁺ at higher temperature (>200° C.). The mass spectrum for a straight-chain alkane equimolar mixture (C₂₁-C₄₀) shows nearly equal ionization efficiency for all components. AP/LIAD-CI produces molecular weight distributions similar to those for gel permeation chromatography for polyethylene polymers, POLYWAX® 500 and POLYWAX® 655 (fully saturated homopolymers of ethylene that exhibit a high degree of linearity and crystallinity. These synthetic waxes have narrow molecular weight distributions with a typical polydispersity (Mw/Mn) of 1.08). Coupling of the technique to Fourier transform ion cyclotron resonance mass spectrometry (FT-ICR MS) for the analysis of complex hydrocarbon mixtures provides unparalleled resolution and mass accuracy to facilitate unambiguous elemental composition assignments: e.g., 1,754 peaks (rms error=175 ppb) corresponding to a paraffin series (C₁₂-C₄₉, double bond equivalents, DBE=0) and higher DBE series corresponding to cycloparaffins containing 1 to 8 rings. Isoabundance-contoured DBE vs. carbon number plots highlight steranes of carbon number C₂₇ to C₃₀ and DBE=4, as well as hopanes of C₂₉ to C₃₅ (DBE 5), with sterane-to-hopane ratio in general agreement with field ionization/field desorption (FI/FD) mass spectral analysis, but performed at atmospheric pressure. The overall speciation of nonpolar, aliphatic hydrocarbon base oil species offers a promising diagnostic probe to characterize crude oil and its products.

### BRIEF DESCRIPTION OF THE DRAWINGS

These and other features, aspects, and advantages of the present invention will become better understood with reference to the following description and appended claims, and accompanying drawings where:

FIGS. 1A-C show schematic diagram of the AP/LIAD-CI source interfaced to a linear ion trap mass spectrometer (the source was also coupled to a 9.4 T FT-ICR mass spectrometer in the same configuration);

FIG. 2 shows a plot of relative abundance of various reagent ions against O₂ flow rate, showing the effect of O₂ gas flow rate on linear ion trap mass spectra for several reagent ions;

FIG. 3 shows a linear ion trap mass spectrum generated by a corona discharge in 5 L/min N₂;

FIG. 4 shows AP/LIAD-CI linear ion trap mass spectra for a straight-chain alkane (triacontane, C₃₀H₆₂) at each of several O₂ gas flow rates. The heated metal capillary was held at 150° C. and biased at 25 V, and the tube lens was biased at 50 V;

FIG. 5 shows AP/LIAD-CI 9.4 T FT-ICR mass spectra for triacontane with 5 L/min O₂ carrier gas doped with H₂¹⁸O, by flowing the gas through a vial containing 95 atom % ¹⁸O-water for experiments performed at various accumulation period: 0.5 s (top), 1 s (middle), 2 s (bottom);

FIG. 6 shows AP/LIAD-CI linear ion trap mass spectra for triacontane from a corona discharge in 5 L/min O₂ gas flow, at increasing tube lens voltage (top to bottom);

FIG. 7a shows AP/LIAD-CI linear ion trap mass spectra for triacontane (C₃₀H₆₂) obtained with O₂ (top) or N₂ (bottom) carrier/reagent gas. The heated metal capillary was held at 150° C. The insets are the mass scale expanded segments for each linear ion trap mass spectrum together with the corresponding segment obtained with FT-ICR MS;

FIG. 7b shows AP/LIAD-CI linear ion trap mass spectra for an equimolar mixture (40 μg/mL each) of straight-chain alkanes (C₂₁-C₄₀) for O₂ (top) and N₂ (bottom) carrier/reagent gas;

FIG. 8 shows AP/LIAD-CI linear ion trap mass spectra for various straight-chain alkanes with corona discharge in 5 L/min O₂ gas flow: tricosane (top), nonacosane (middle), hexatriacontane (bottom);

FIG. 9 shows AP/LIAD-CI linear ion trap mass spectra for a branched alkane (squalane, C₃₀H₆₂) for O₂ (top) or N₂ (bottom) carrier/reagent gas;

FIG. 10 shows AP/LIAD-CI linear ion trap mass spectra for squalane with a corona discharge in 5 L/min O₂ gas flow, at increasing heated metal capillary temperature (top to bottom);

FIG. 11 shows AP/LIAD-CI linear ion trap mass spectra for a cycloalkane (5-alpha cholestane, C₂₇H₄₈) from corona discharge with O₂ carrier/reagent gas, at several heated metal capillary temperatures;

FIG. 12 shows AP/LIAD-CI linear ion trap mass spectra for a cycloalkane (5-alpha cholestane, C₂₇H₄₈) from a corona discharge with 5 L/min N₂ gas flow, at several heated metal capillary temperatures;

FIG. 13 shows an AP/LIAD-CI linear ion trap mass spectrum for an equimolar mixture of saturated, unsaturated and heteroatom-containing hydrocarbons with a corona discharge in 5 L/min O₂ gas flow.

FIG. 14 shows AP/LIAD-CI 9.4 T FT-ICR mass spectra for each of two polyethylenes, based on a corona discharge with 5 L/min O₂ gas flow. Top: POLYWAX® 500; Bottom: POLYWAX® 655;

FIG. 15a Top: shows an AP/LIAD-CI 9.4 T FT-ICR mass spectrum for a base oil from a corona discharge in O₂ carrier/reagent gas. The mass scale-expanded inset (top, right) highlights the requirement for ultrahigh resolution to separate species that differ in elemental composition by ¹³C vs. CH (4.5 mDa difference in exact mass). Bottom: Isoabundance-contoured plot of double bond equivalents vs. carbon number for the hydrocarbon composition; and

FIG. 15b shows a plot of relative abundance vs. carbon number for paraffins and cycloparaffins, sorted by number of rings, for a base oil sample analyzed by AP/LIAD-CI 9.4 T FT-ICR MS. The signal magnitude for each M⁺. and [M-H]⁺ ion pair was summed before normalization.

It should be understood that the various embodiments are not limited to the arrangements and instrumentality shown in the drawings.

### DETAILED DESCRIPTION OF THE INVENTION

The present invention may be understood more readily by reference to the following detailed description of preferred embodiments of the invention as well as to the examples included therein. All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

In the context of the present disclosure, the term “atmospheric pressure” is not limited to an exact value for atmospheric pressure such as 1 atmosphere (760 Torr) at sea level. Instead, the term “atmospheric pressure” also generally encompasses any pressure that is substantially at (i.e., about, approximately, or near) atmospheric pressure. Accordingly, “atmospheric pressure” generally encompasses a range of pressures within a range having a lower limit and/or an upper limit. The range can include or exclude the lower limit and/or the upper limit. The lower limit and/or upper limit can be selected from 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, and 820 Torr. For example, according to certain preferred embodiments, “atmospheric pressure” generally encompasses a range of pressures from about 720 Torr to about 800 Torr.

According to various embodiments, LIAD can be coupled with CI at atmospheric pressure to a Fourier transform ion cyclotron resonance mass spectrometer to achieve the advantages of atmospheric pressure implementation for the analysis of polar and nonpolar polyaromatic components of a petroleum distillate. An extension of these embodiments can also be made to the analysis of saturated hydrocarbons, including straight-chain, branched-chain, and cycloparaffins with little or no fragmentation by use of a modified sample probe(s) with O₂ reagent/carrier gas. Various embodiments present an application of the new method to 1) analysis of polyethylene to yield molecular weight distributions similar to GPC, and 2) analysis of a complex saturated hydrocarbon matrix (base oils) with molecular weight distribution nearly identical to that from FD/FI, but superior to FI with respect to throughput, cost, and robustness afforded by atmospheric pressure implementation.

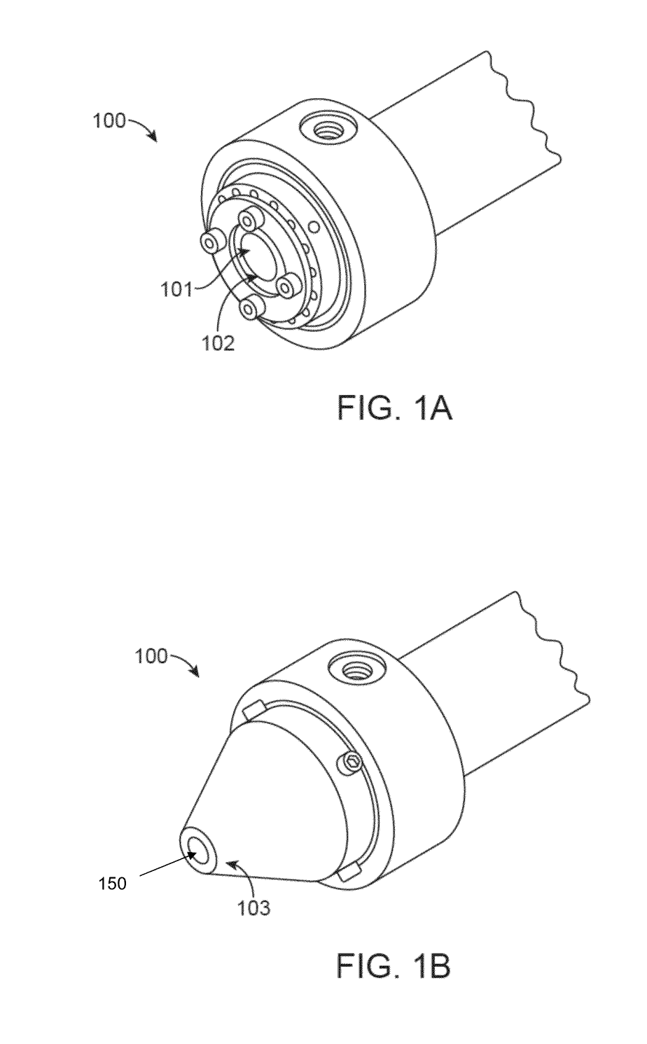

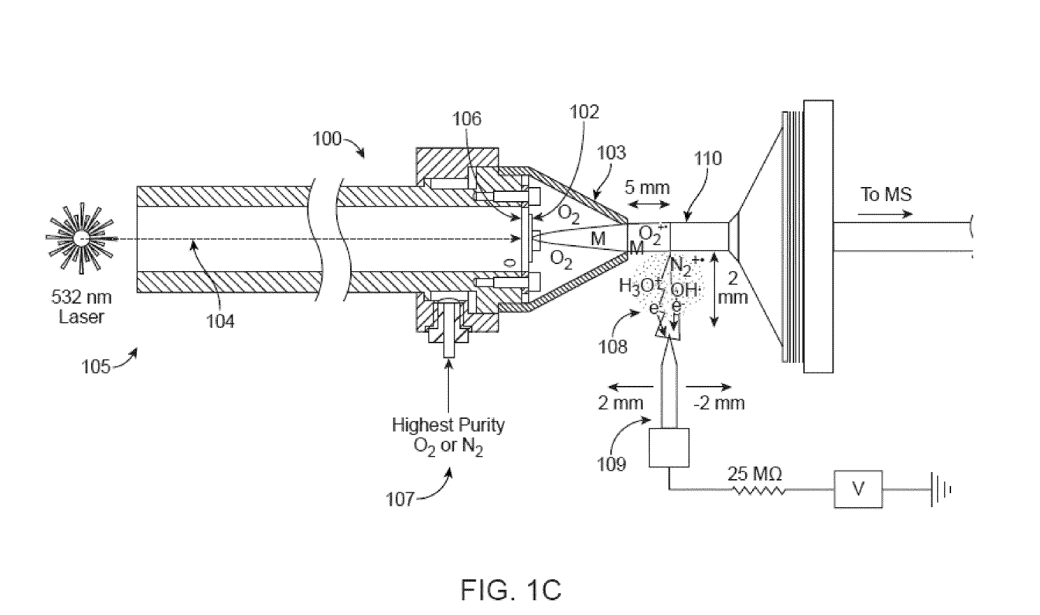

Referring to FIGS. 1A, 1B, and 1C, a system 100 according to various embodiments is illustrated. Analytes 101 can be deposited on a thin metal foil 102 and irradiated from the back side 106 with high energy laser pulses 104 from a laser source 105. A high amplitude laser-induced shock wave (energy density >0.7×10⁸ W/cm²) propagates through the foil to liberate analytes 101 into the gas phase from the opposite side 106 into a stream of reagent gas 107 that exits through a conical stainless steel piece 103. The conical piece 103 can be made of any suitable material and is not limited to stainless steel. The conical piece can be positioned a distance from the MS capillary 110 within a range having a lower limit and/or an upper limit. The range can include or exclude the lower limit and/or the upper limit. The lower limit and/or upper limit can be selected from 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20 mm. For example, according to certain preferred embodiments, the conical piece can be positioned a distance from the MS capillary 110 of about 5 mm. The conical piece can comprise an outlet 150.

The reagent gas facilitates the transport of vaporized analytes toward the MS inlet and also serves to purge the region surrounding the MS inlet capillary of atmospheric gases, thereby controlling the ionization environment. A corona discharge 108 between a tungsten electrode 109 placed orthogonally with respect to the MS inlet capillary 110 generates reagent ions for chemical ionization of analytes by hydride abstraction, charge exchange and proton transfer, depending on the choice of reagent gas. The needle could be translated along the length of the mass spectrometer capillary inlet by ±2 mm about the inlet, and up to 5 mm away from the external surface of the capillary with increase in the needle voltage (2-5 kV). In other words, the needle can be positioned away from the external surface of the capillary by a distance within a range having a lower limit and/or an upper limit. The range can include or exclude the lower limit and/or the upper limit. The lower limit and/or upper limit can be selected from 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, and 6 mm. For example, according to certain preferred embodiments, the needle can be positioned away from the external surface of the capillary by a distance in a range of from 2 to 5 mm. The angle between the needle and the capillary can also be varied within a range having a lower limit and/or an upper limit. The range can include or exclude the lower limit and/or the upper limit. The lower limit and/or upper limit can be selected from 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, and 130 degrees. For example, according to certain preferred embodiments, the angle between the needle and the capillary can also be varied between 30 to 120 degrees. This disclosure also embodies any method for the vaporization of analytes such as thermal desorption and gas chromatography.

The use of oxygen as reagent gas provides a means for the global analysis of all hydrocarbon species. It allows the relative quantitative ionization of saturated hydrocarbons by hydride abstraction and/or charge exchange with little or no fragmentation. Olefins undergo hydride abstraction, charge exchange and/or protonation in that order with increased degree of unsaturation. Polyaromatic hydrocarbons (PAHs) and heteroatom-containing (O, N, S) hydrocarbons are observed either as molecular ion or protonated molecule.

When nitrogen is used as reagent gas, all hydrocarbon classes are observed predominantly as molecular ion(s). In this case branched alkanes result in significant fragmentation following the low energy pathways prevalent in collision induced dissociation (CID) to provide structural information and a means of distinguishing between isomers.

Field desorption, field ionization and vacuum LIAD-CI could provide similar results but are performed in vacuum and require special instrumentation/set-up and contain labor intensive/time consuming sample preparation and vacuum introduction steps limiting their appeal. Operation in vacuum thus significantly limits throughput. Various embodiments of the present invention take advantage of operation at atmospheric pressure to allow implementation on any modern mass spectrometer with at AP interface promising more broad scale utility for applications in the analysis of hydrocarbon mixtures. The technique has been implemented on a custom-built 9.4 T Fourier-transform Ion cyclotron resonance mass spectrometer and a commercial linear quadrupole ion trap mass spectrometer and showed applications in the analysis of saturated hydrocarbon mixtures, hydrocarbon polymers, whole crude oil, synthetic hydrocarbon crude oil, petroleum fractions and distillates, mineral oil and base oil.

### EXAMPLES

### Experimental Methods

### Reagents and Samples.

All reagents and samples were used without additional purification. HPLC grade toluene (99.9%, Sigma Aldrich, St. Louis, Mo., USA) was used for samples dissolution and dilution. Ion source optimization and characterization experiments were performed by use of the following saturated hydrocarbon model compounds: triacontane, tricosane, hexatriacontane, squalane, 5 alpha cholestane, alkane mixture C₂₁-C₄₀, Polywax® 500, Polywax® 655, squalene, coronene, ellipticine, benzo[a]dibenzothiophene, 2,7-di-tert-butyl-9H-fluorene-9-carboxylic acid; purchased from Sigma Aldrich. The optimized method was applied to analysis of a premium base oil sample. Ultra-pure carrier grade O₂ (99.996%, OX UPC 300, Airgas South, Inc., Tallahassee, Fla.) and BIP® technology grade N₂ (99.9999%, NI BIP300) were used as carrier/reagent gases.

### AP/LIAD-CI Ion Source

A previously described AP/LIAD-CI FT-ICR MS interface was modified as follows. The ion source was coupled to a 9.4 T FT ICR and a linear ion trap mass spectrometer through a reconfigured Thermo Finnigan (San Jose, Calif., USA) APCI source. The sample probe was modified to provide a pathway for introduction and confinement of the flow of reagent gas and vaporized analytes. The probe consists of a hollow PEEK cylinder (131 mm long, 11 mm i.d., 18.4 mm o.d., Upchurch Scientific, Oak Harbor, Wash., USA) and a screw-on PEEK fitting on one end (14 mm long, 18.4 mm i.d., 31 mm o.d.,) to create a small volume for directed carrier/reagent gas introduction (FIG. 1A). The reagent gas enters that volume through a ⅛″ Swagelok fitting and exits through sixteen 1.2 mm diameter channels in the PEEK cylinder. That end of the probe is fitted with a hollow stainless steel disk (1.3 mm thickness, 11 mm i.d., 18.4 mm o.d.) used to sandwich a sample-containing piece of Ti foil (12.7 μm thickness) onto the PEEK cylinder with the gas flow channels within the periphery of the disk. The disk is held in place by four set screws mounted on the disk and threaded into the PEEK body. A stainless steel cone (initial i.d.=21.8 mm, o.d.=24.4 mm, length=21.5 mm, tapered to 4 mm i.d.) is mounted on the PEEK assembly and held in place by 4 set screws for confinement of the gas flow and LIAD vaporized analytes (FIG. 1B). The probe is inserted in the source chamber by use of the aperture that normally holds the CI needle and secured in its associated screw fitting. The probe can be translated back and forth to adjust the sample-to-MS distance. It can also be rotated about its longitudinal axis to expose different positions on the back side of the Ti foil (Alfa Aesar, Ward Hill, Mass., USA) to the laser beam during LIAD. The port that normally holds the voltage connection to the heater is adapted to hold a male-to-male Swagelok® fitting (Swagelok Company, Solon, Ohio, USA) connected to ⅛″ teflon tubing at both ends. One end was connected to the gas supply line and the other end connected to the sample probe. An in-line molecular sieve water vapor trap (Sigma Aldrich, St. Louis, Mo., USA, not shown in FIG. 1C) was placed in the gas line to reduce residual moisture. The carrier gas flow rate was ˜5 L/min unless stated otherwise. The sheath gas/sample introduction port of the source chamber was adapted to hold a corona discharge needle made from a sharpened tungsten electrode (Welding Supply, Elk Grove Village, Ill., USA). Electric discharge was initiated between the tungsten electrode regulated from 2.5-4.5 kV by a high-voltage power supply (SRS PS350, Sunnyvale, Calif., USA) and the MS inlet capillary held at 20-50 V (discharge current, 9-12 μA). The needle is orthogonal to the MS capillary inlet, 1-2 mm away from the outer surface (FIG. 1 bottom). The back side of the foil is irradiated with a Q-switched Nd:YAG laser (532 nm), that is pulsed at 10 Hz, with pulse energy ranging from 53-105 mJ and pulse duration of ˜5 ns.

### Sample Preparation for AP/LIAD-CI

A stock solution (10 mM) of each saturated hydrocarbon model compound in toluene was diluted to 1 mM for characterization experiments. The polywax and base oil samples were diluted to 1 mg/mL prior to analysis and the standard alkane mixture (C₂₁-C₄₀) was spotted as received (40 μg/mL each in toluene). 2 μL of each sample was spotted onto the Ti foil. After solvent evaporation the stainless steel cone was mounted and the probe inserted into the source chamber. The gas line was then connected and the cone-to-MS distance adjusted to ˜5 mm unless stated otherwise. The gas flow and the discharge was turned on for about ˜10-30 s followed by laser irradiation of the back side of the foil. LIAD-vaporized neutrals are entrained by the carrier gas and swept toward the MS inlet where they are ionized by reaction with reagent ions from the carrier generated by corona discharge.

### Linear Ion Trap Mass Spectrometry (LIT MS)

All ion source optimization and characterization experiments were performed with an LIT mass analyzer (LTQ, Thermo Finnigan San Jose Calif., USA) equipped with automatic gain control. Typical instrument parameters were: capillary voltage, 50 V, capillary temperature, 150° C. (unless stated otherwise), and tube lens voltage, 25 V. Data were acquired and processed by use of Xcalibur version 2.0 software (Thermo Fisher Scientific, San Jose, Calif., USA). Each mass spectral scan consisted of 3 microscans, 100 ms maximum ion injection period. All experiments were performed with positive ions.

### 9.4 T FT-ICR MS and Data Analysis

The polyethylene and base oil samples were analyzed with a custom-built 9.4 T FT-ICR mass spectrometer for determination of polymer molecular weight distribution and composition as follows. AP/LIAD-CI generated ions traverse a heated metal capillary into a first octopole trap, in which the ions are accumulated for a very short period (70 ms). The ions are then transferred through a quadrupole ion guide to a second octopole trap, in which they are further accumulated for a total of 20 injections from the first octopole. Ultrapure carrier grade helium gas (99.9995%, Air Gas South Inc. Tallahassee Fla.) was introduced into the second octopole to collisionally cool the ions prior to transfer through a set of rf-only quadrupole ion guides (120 cm total length) into an open cylindrical ion trap (9.4 cm i. d., 30 cm long). The ions are cyclotron-excited by broadband frequency sweep (chirp) excitation and were subsequently detected as the differential current induced between two opposed electrodes of the ICR cell. For each AP/LIAD-CI MS experiment 1-15 digitized time-domain ICR transients, corresponding to 10-150 laser shots were collected and averaged, with the LIAD probe manually rotated at ˜7 revolutions per minute about its longitudinal axis during the data acquisition period. Each of the acquisitions was Hanning-apodized and zero-filled prior to fast Fourier transform and magnitude calculation. The experimental event sequence was controlled by a modular ICR data acquisition system.

The AP/LIAD-CI FT-ICR mass spectrum of the base oil sample was internally calibrated with respect to a highly abundant homologous alkylation series. Singly charged ions with relative abundance greater than six standard deviations of the baseline root-mean-square (rms) noise were exported to a spreadsheet, after identification of homologous series (i.e., species with the same NₙOₒSₛ content and number of rings plus double bonds, differing only by degree of alkylation) and peak assignment based on accurate mass and appropriate elemental constraints. For each elemental composition, C_{c}HₙNₙOₒSₛ, the heteroatom class, type (double bond equivalents, DBE, defined as the number of rings plus double bonds to carbon), and carbon number, c, were tabulated for generation of graphical DBE vs. carbon number images.

### Results and Discussion

### Ion Source Optimization: Straight-Chain Alkanes

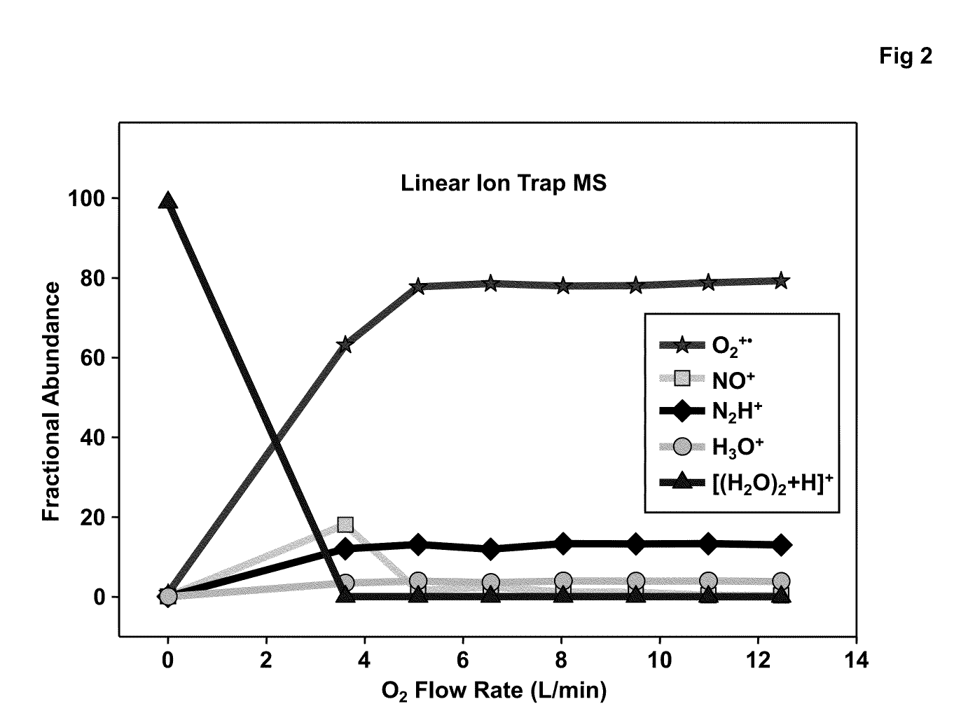

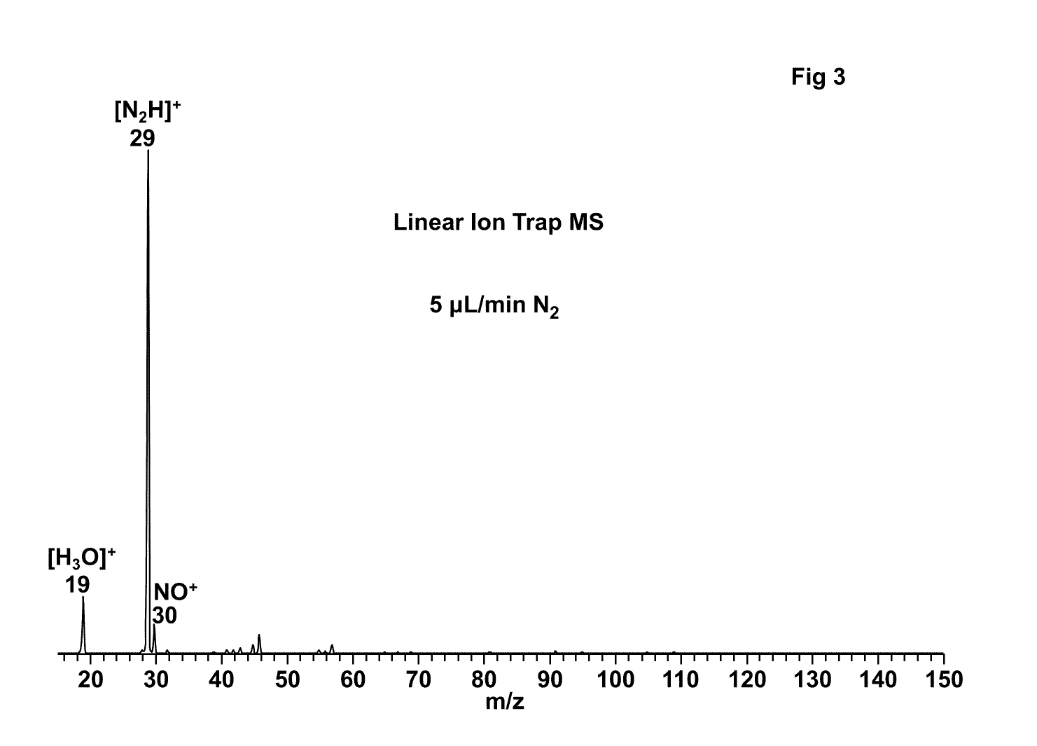

The performance of the new sample probe for analysis of saturated hydrocarbons was characterized and optimized by use of O₂ and N₂ as reagent gas. The reagent gas plays three main roles: (1) to serve as a carrier gas for entrainment of LIAD vaporized analytes, which are directed toward the MS heated metal capillary (HMC) inlet; (2) to evacuate the region surrounding the MS inlet capillary of atmospheric gases, thereby controlling the ionization environment; and (3) to generate reactive species for chemical ionization. FIG. 2 shows the effect of O₂ gas flow rate on the relative abundance of various reagent ions, based on scanning the low-mass range (m/z 15-200) of the linear ion trap, after initiation of corona discharge. In the absence of O₂ gas flow the mass spectrum is dominated by [(H₂O)₂+H]⁺, originating from water content of the ambient air surrounding the HMC capillary inlet. Once the O₂ gas is turned on, the O₂⁺. relative abundance increases sharply to become the dominant species, leveling off at flow rate >5 L/min, whereas [(H₂O)₂+H]⁺ decreases sharply to near zero due to depletion of the room air moisture in the source region. The relative abundance of NO⁺ increases slightly at 3.6 L/min O₂ gas flow rate, presumably due to an increased rate of reaction of O₂ and N₂ to generate NO⁺, as the concentration of O₂ at the inlet capillary increases. However, the NO⁺ signal decreases to near zero at higher O₂ gas flow rate, following complete evacuation of the ambient air N₂ by the high gas flow. The signal magnitudes for low-abundance background ions, N₂H⁺ and H₃O⁺, show little dependence on the O₂ gas flow rate. The use of N₂ as carrier/reagent gas exhibited similar behavior, except that N₂H⁺ was the dominant species at high gas flow rate (>3.6 L/min FIG. 3) and O₂⁺. was absent.

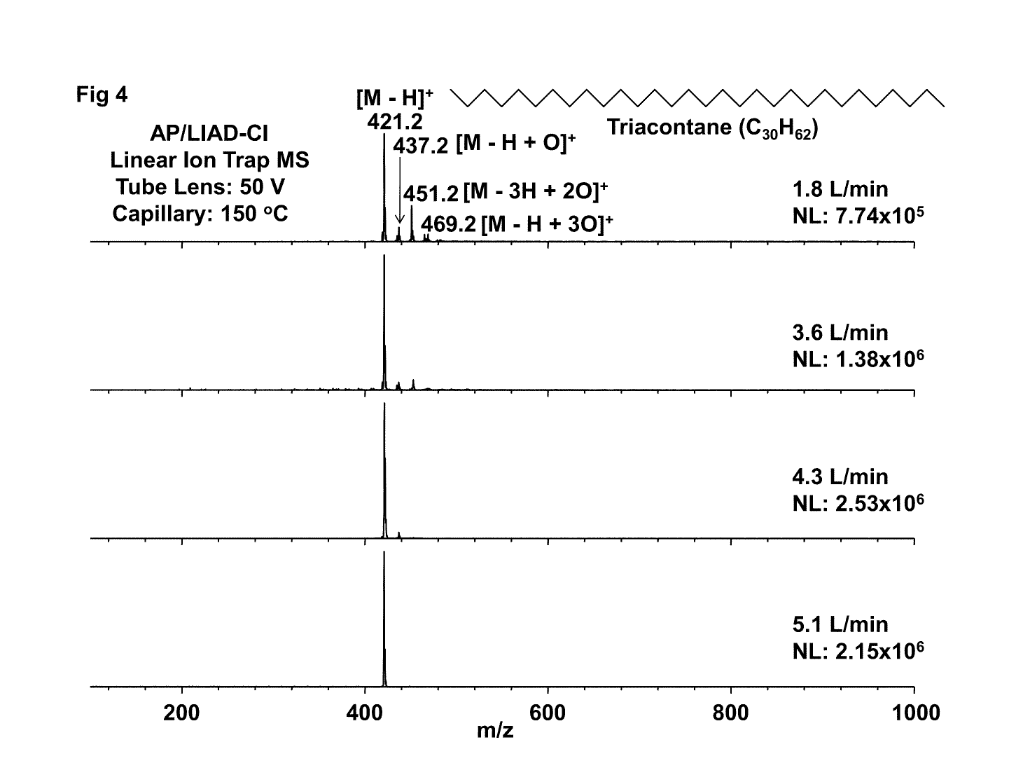

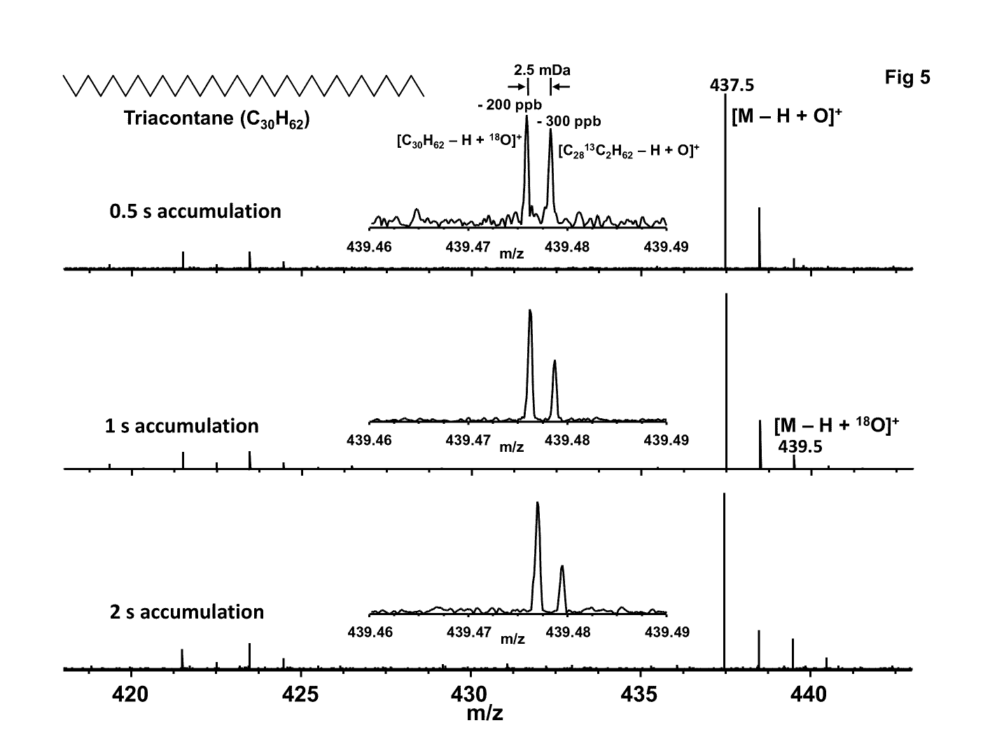

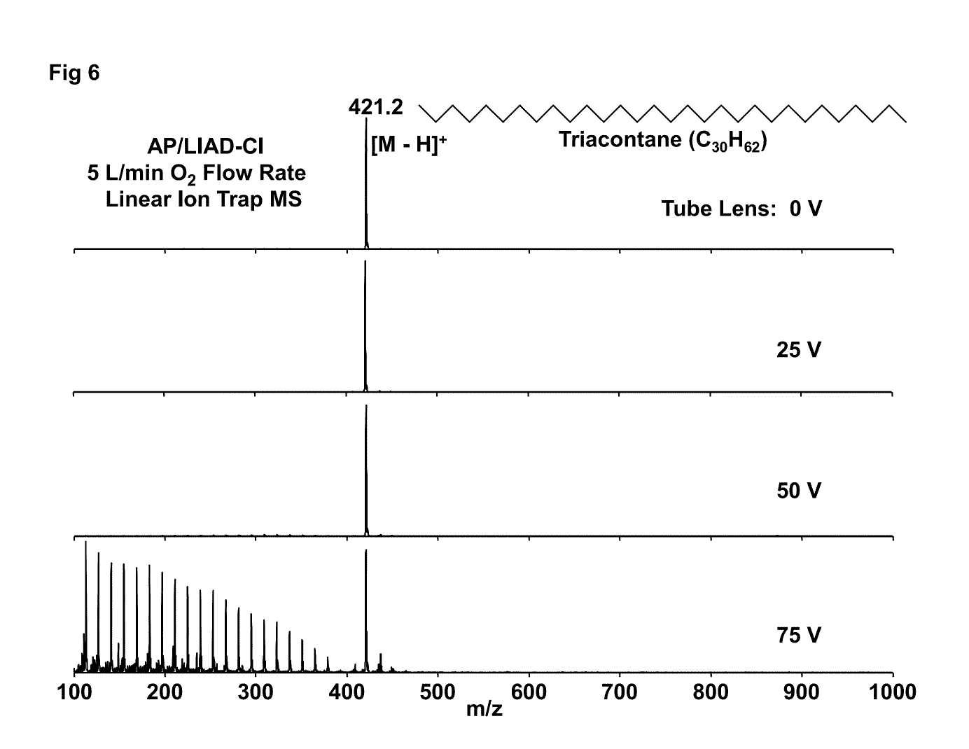

AP/LIAD-CI MS optimization experiments for analysis of saturated hydrocarbons were performed by use of the straight-chain alkane, triacontane (C₃₀H₆₂). The carrier gas flow rate was the most critical parameter that determined the abundance and distribution of analyte ions. No analyte signal was observed in the absence of carrier gas presumably because the kinetic energy of the LIAD-vaporized neutrals is rapidly attenuated by collisions with atmospheric gases. The carrier gas thus serves to entrain the gas-phase analyte molecules as they approach the MS capillary inlet. FIG. 4 shows mass spectra at each of four O₂ gas flow rates. At 1.8 L/min O₂, [M-H]⁺ (hydride abstraction) dominates. Species corresponding to various degrees of oxidation (addition of up to 4 oxygen atoms) are also evident. The relative abundance of [M-H]⁺ increases with O₂ gas flow rate due to increased abundance of O₂⁺. available for CI (see above). The magnitudes of the peaks that correspond to analyte oxidation decrease with increased O₂ gas flow rate, and correlate with depletion of the ambient moisture in the cone-HMC interface. This observation suggests a role for atmospheric water in the generation of oxidation products, previously identified as hydrated analyte ions e.g., [M-3H+H₂O]⁺ at m/z 437.2. This assertion was verified by incorporation of H₂¹⁸O into the flow of O₂ carrier gas for AP/LIAD-CI analysis of triacontane (C₃₀H₆₂), by bubbling the gas through a vial containing 95 atom % ¹⁸O-water (Sigma Aldrich, St. Louis, Mo., USA). This experiment was performed with a 9.4 T FT-ICR mass spectrometer to provide ultrahigh resolution (m/Δm₅₀%>1,000,000 at m/z 400) and mass accuracy (<400 ppb) to unambiguously resolve and identify the signals. [C₃₀H₆₂—H+O]⁺ dominates the spectrum (FIG. 5) which also shows an abundant signal for [C₃₀H₆₂—H+¹⁸O]⁺ that differs from [¹²C₂₈¹³C₂H₆₂—H—O]⁺ by only 2.5 mDa. The relative abundance of [C₃₀H₆₂—H+¹⁸O]⁺ increases with the accumulation period which verifies that oxidation species are generated from hydration reactions. Alkane oxidation signals were minimized to less than 1% at 5.1 L/min O₂ gas flow rate, which was used for all subsequent experiments, for which [M-H]⁺ is the main analyte ion detected, with no fragmentation, even if the capillary temperature is increased to 350° C. However, minimal fragmentation does occur if the tube lens voltage is increased from 25 V to 50 V and becomes significant at 75 V (FIG. 6), an effect that could be exploited to provide structural information. Optimization of the cone-to-MS distance resulted in optimal signal magnitude at ˜5 mm. In general, the signal magnitude did not vary much (RSD=25%) within the tested range (3-11 mm) indicating that the sample cone very efficiently confines the carrier gas/analyte stream moving toward the MS inlet. At the optimal ion source settings (carrier gas flow rate=5.1 L/min, tube lens voltage=25 V, capillary temperature=150° C., capillary voltage=25 V and cone-to-MS distance=5 mm), the detection limit determined by spotting serially diluted triacontane was 30 fmol.

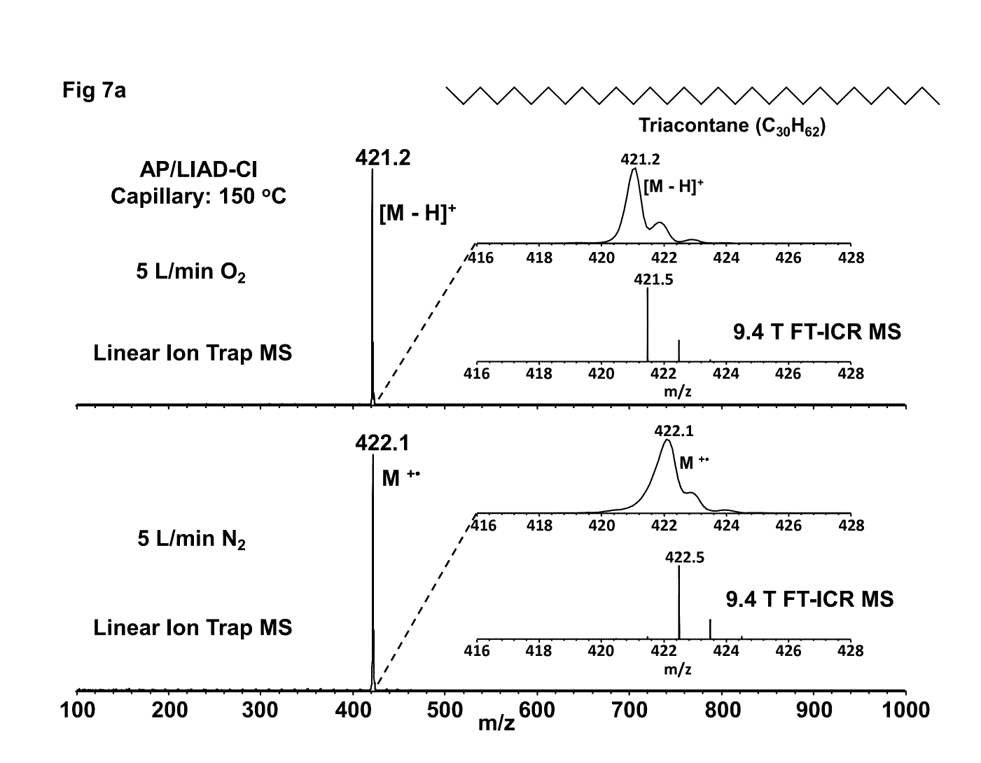

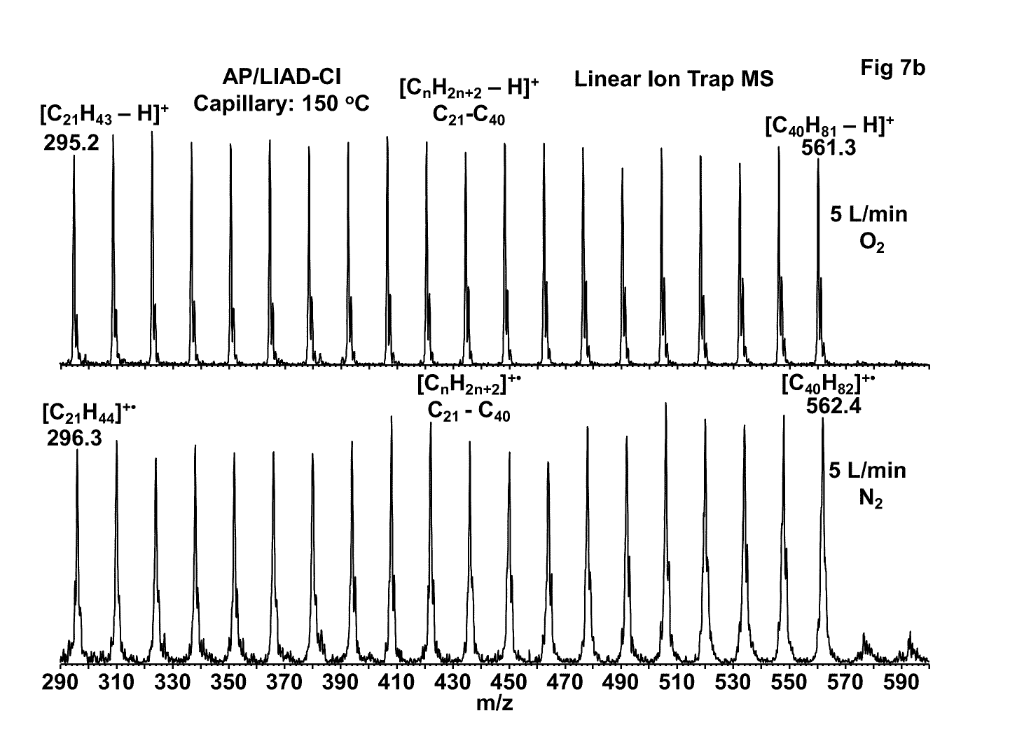

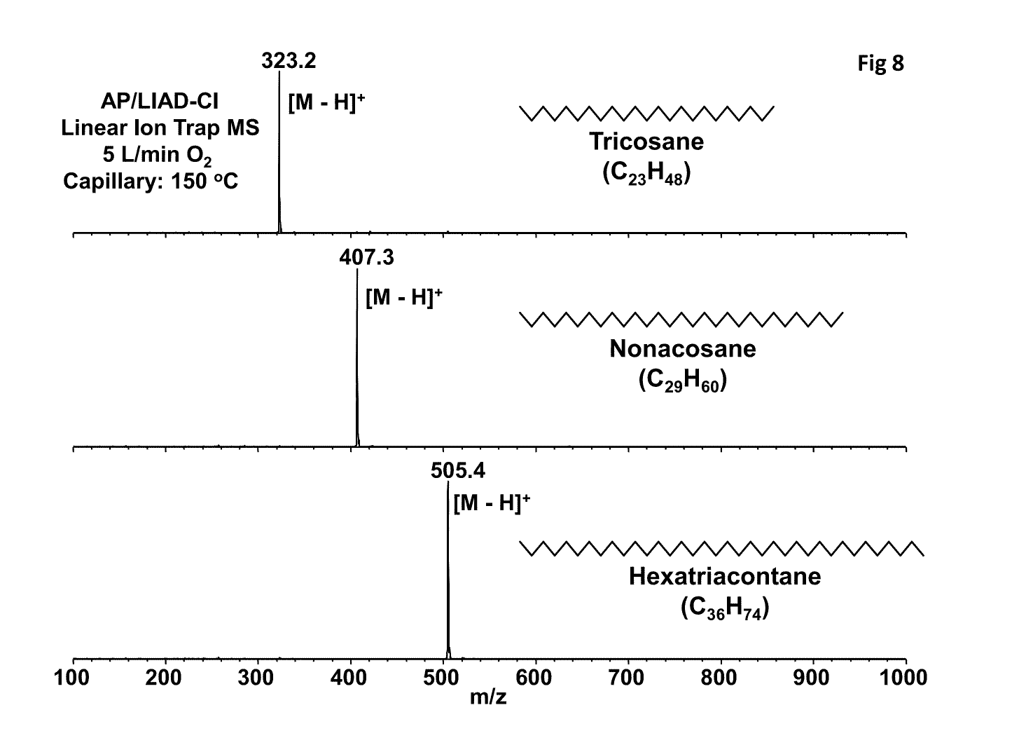

FIG. 7a identifies the analyte signals from use of O₂ vs. N₂ as carrier/reagent gas, as clarified by 9.4 T FT-ICR mass scale-expanded insets. [M-H]⁺ is detected exclusively with O₂ as carrier gas (FIG. 7a, top). Similar results were obtained for tricosane (C₂₃H₄₈), nonacosane (C₂₉H₆₀) and hexatriacontane (C₃₆H₇₄, FIG. 8), auguring for successful analysis of complex saturated hydrocarbon mixtures. With N₂, (FIG. 7a, bottom), the molecular ion, M⁺. dominates the mass spectrum, with lower abundance ion signals corresponding to losses of H and H₂ presumably from M⁺., together with minor fragment ions. M⁺. is generated by charge exchange with nitrogen radical cations, and undergoes some fragmentation due to the relatively larger difference in ionization energy between M and N₂ compared to O₂.

FIG. 7b shows a similar comparison between O₂ and N₂ carrier/reagent gas for an equimolar straight-chain alkane mixture (C₂₁-C₄₀). The mass spectra show nearly equal signal magnitudes for all the alkanes in the range, as [CₙH₂ₙ₋₂—H]⁺ (n=21-40) with somewhat more uniform ionization efficiency for O₂ (RSD=4.0%, FIG. 7b, top) than N₂ (RSD=7.6%, FIG. 7b bottom) carrier/reagent gas, which shows [CₙH₂ₙ₊₂]⁺. species. The technique clearly holds promise for accurate relative quantitation for such mixtures. Moreover the use of O₂ carrier gas yields overall 2.5-folds greater signal magnitude than N₂. Presumably, the lower ionization energy of O₂ (12.1 eV) relative to N₂ (15.6 eV) results in more reagent ions available for more efficient CI.

### Branched Alkanes

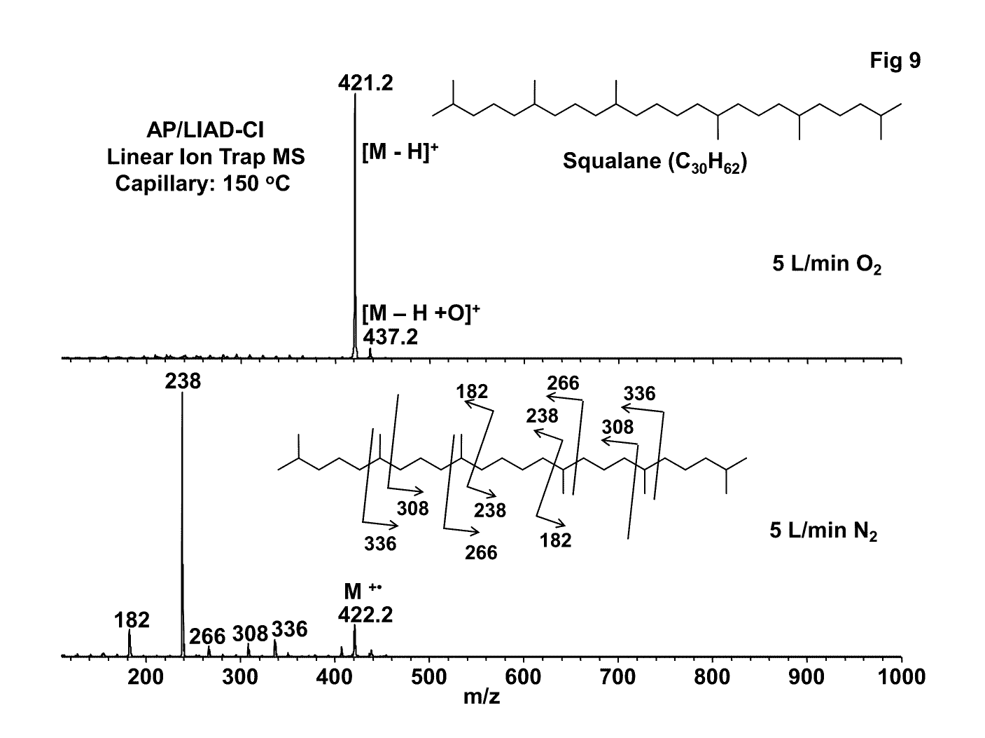

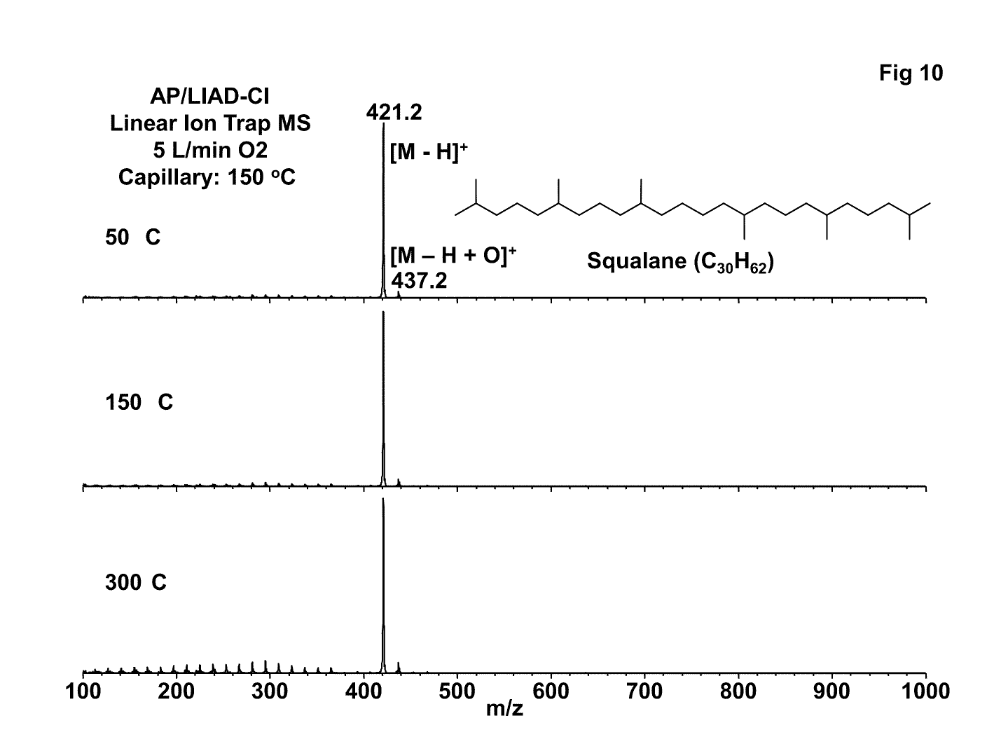

The feasibility of AP/LIAD-CI MS for branched alkanes was tested by use of squalane (C₃₀H₆₂), a constitutional isomer of triacontane. FIG. 9 shows the results for O₂ (top) and N₂ (bottom) carrier/reagent gas. With O₂, [M-H]⁺ dominates the spectrum, with small peaks corresponding to fragment ions and [M-H+O]⁺ (FIG. 9, top). The relative abundance of the fragment ions increases slightly with an increasing heated metal capillary temperature (FIG. 10). In contrast, similar analysis by FD/FI results in almost complete dissociation of the molecular ion. AP/LIAD-CI with O₂ reagent gas thus offers a softer ionization approach for analysis of branched alkanes. With N₂ carrier/reagent gas, analyte fragment ion signals constitute the major peaks in the AP/LIAD-CI MS spectrum (FIG. 9, bottom). The fragment ions are characteristic of collision-induced dissociation (CID), which generates highly stable tertiary carbocation fragments. The larger collisional cross section of squalane relative to its isomeric counterpart, triacontane, is responsible for its higher gas-phase reactivity and higher degree of fragmentation/oxidation. The ability for N₂ reagent gas to cause bond cleavages at the branching points could be useful for differentiation of isomeric alkanes.

### Cycloalkanes

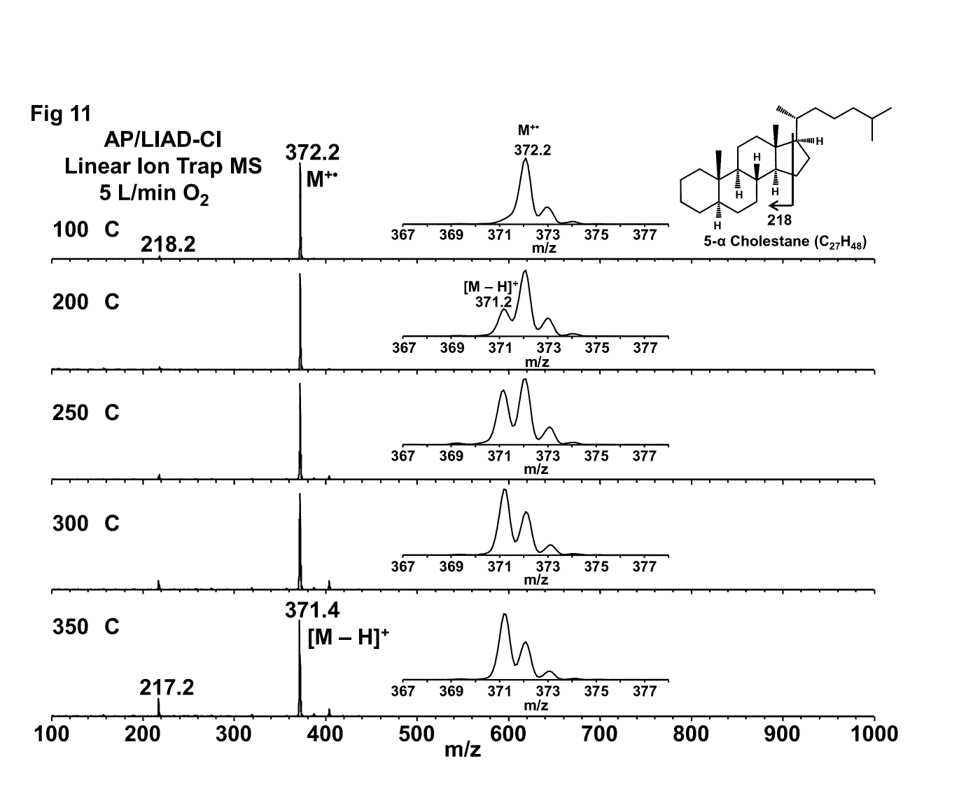

The petroleum biomarker, 5-alpha cholestane (C₂₇H₄₈) serves a model compound to evaluate performance of the ion source for analysis of cycloalkanes. With O₂ as carrier/reagent gas, analyte signal distribution depended on the temperature of the heated metal capillary (FIG. 11). M⁺. dominates the spectrum at HMC temperature below 100° C., with a minute fragment ion signal at m/z 218.2 generated by cleavage across the D-ring of the sterane moiety (FIG. 11, top right). Above 100° C., a peak corresponding to [M-H]⁺ appears in the spectrum together with M⁺.. The abundance of [M-H]⁺ increases relative to M⁺. with increasing HMC temperature. [M-H]⁺ becomes the main intact analyte ion detected at HMC temperature above 350° C. The analyte fragment ion also undergoes an m/z 218.2 to m/z 217.2 transition with increasing HMC temperature, due to loss of a hydrogen radical from the androstane moiety of the analyte. The magnitude of the fragment ion signal increases with increasing HMC temperature due to thermal activation of the precursor.

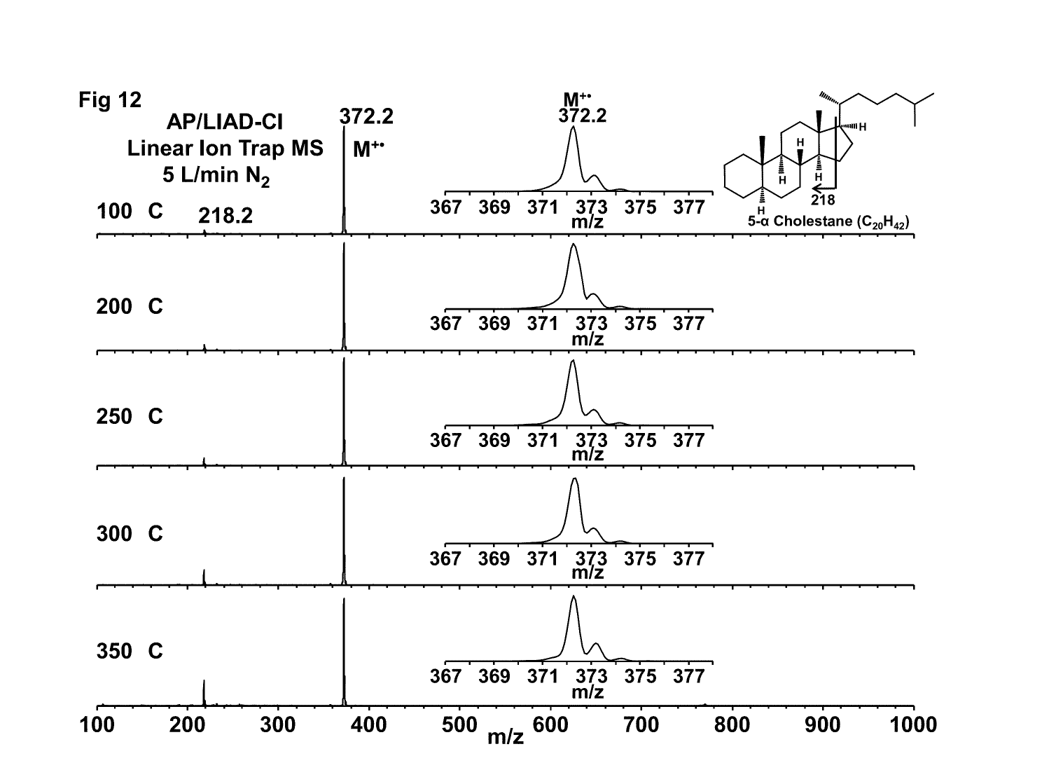

With N₂ carrier/reagent gas, M⁺. dominates the spectrum, with no [M-H]⁺ at any HMC temperature (100-350° C. FIG. 12), and the fragment ion doesn't lose hydrogen at high HMC temperature. The predominant pathway leading to hydride abstraction evidently requires O₂ and occurs in two steps. The data is consistent with an earlier proposed mechanism that occurs via an [M⁺.]* transition state, generated in this case by thermal activation of M⁺., which then reacts with O₂ by abstraction of a hydrogen radical according to the scheme below, in which R denotes alkyl chains.

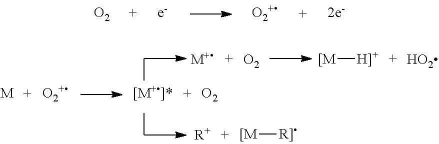

### Saturated, Unsaturated and Heteroatom-Containing Hydrocarbon Mixture

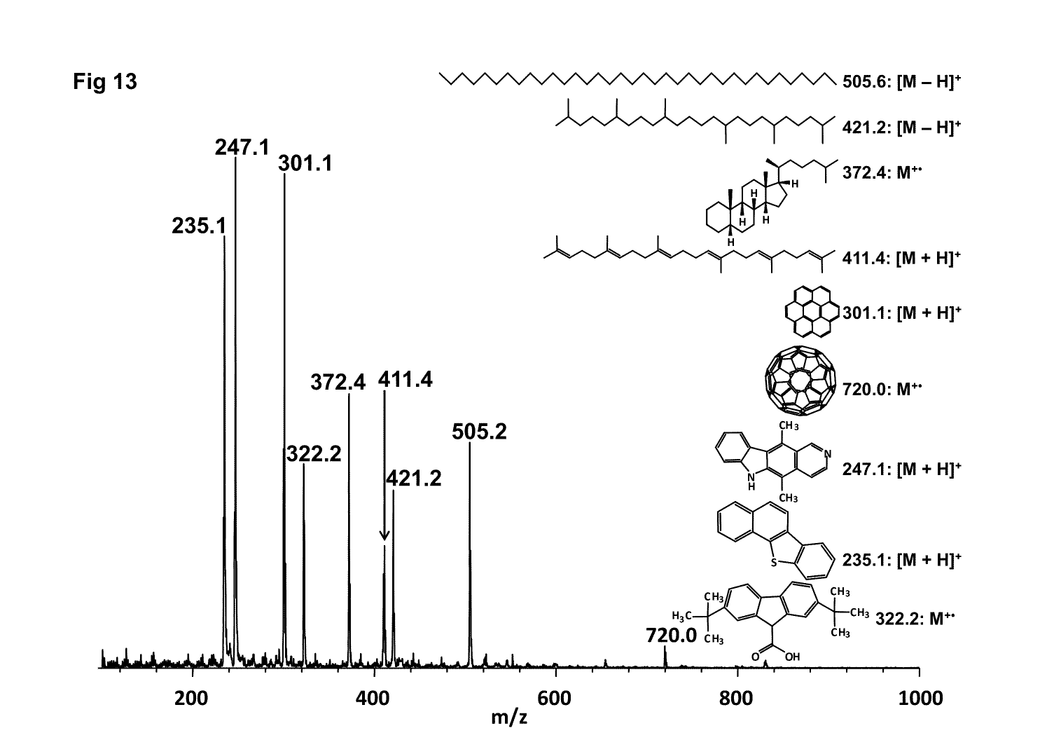

AP/LIAD-CI by use of O₂ reagent/career gas is however not limited to the analysis of saturated hydrocarbons. FIG. 13 demonstrate the capability of the technique for the simultaneous analysis of a broad range of compound classes present in crude oil including: saturated, unsaturated nonpolar and polar heteroatom-containing hydrocarbons. These results are also summarized on Table 1 for individual compounds and for the mixture. The saturated acyclic and cycloalkanes undergo hydride abstraction and/or charge exchange whereas the acyclic olefins, polyaromatic, fullerene and heteroatom-containing hydrocarbons are observed as the molecular ion and/or protonated molecule. The multiple ionization channels provided by this technique enable potential applicability in the analysis of the entire spectrum of chemical species present in crude oil. Its utility is however not limited to crude oil analysis. It could also be applied in the analysis of drug molecules, metabolites, synthetic chemicals etc.

Table 1 shows relative abundance and detection limits of various individual petroleum model compounds and their mixture by AP/LIAD-CI LIT MS with O₂ carrier/reagent gas.

TABLE 1

| | | | Relative | Detection Limit | |
|---|---|---|---|---|---|
| Name | | Observed | Abundance | (pmol) | |
| (MW) | Structure | Ion | (%) | Neat | In Mixture |
| n-hexatria- contane (506.98) | 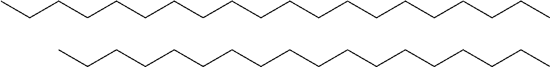 | [M − H]⁺ | 100 | 1.4 | 15.4 |
| Squalane (422.81) | 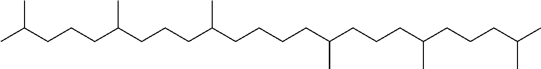 [SMILES: CC(C)CCCC(C)CCCC(C)CCCCC(C)CCCC(C)CCCC(C)C] | [M − H]⁺ minute fragments | 100 <2 | 1.8 | 42.1 |
| 5-alpha cholestane (372.67) | 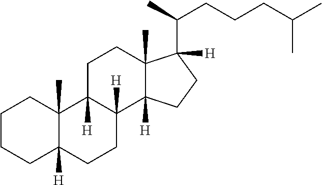 | M^{+•} m/z 218 | 100 3 | 2.0 | 20.6 |
| Squalene (410.72) | 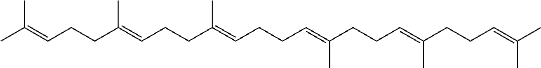 [SMILES: CC(C)=CCC/C(C)=C/CC/C(C)=C/CC/C=C(\C)CC/C=C(\C)CCC=C(C)C] | [M + H]⁺ M^{+•} | 100 31 | 2.3 | 60.9 |
| Coronene (300.35) | 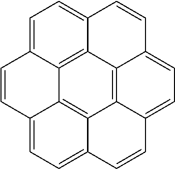 [SMILES: c1cc2ccc3ccc4ccc5ccc6ccc1c1c2c3c4c5c61] | [M + H]⁺ M^{+•} | 100 35 | 2.4 | 14.2 |
| C₆₀ (720.64) | 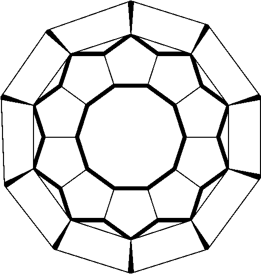 | [M + H]⁺ M^{+•} | 23 100 | 11.0 | 45 |
| Ellipticine (246.31) | 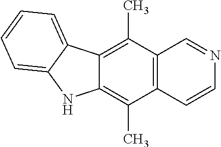 [SMILES: Cc1c2ccncc2c(C)c2c1[nH]c1ccccc12] | [M + H]⁺ M^{+•} | 100 10 | 1.2 | 12.3 |
| Benzo[a] dibenzo- thiophene (234.32) | 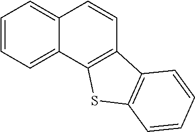 [SMILES: c1ccc2c(c1)ccc1c3ccccc3sc21] | [M + H]⁺ M^{+•} | 100 32 | 1.2 | 19.8 |
| 2,7-di-tert- butyl-9H- fluorene-9- carboxylic acid (322.44) | 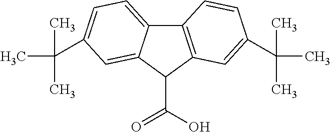 [SMILES: CC(C)(C)c1ccc2c(c1)C(C(=O)O)c1cc(C(C)(C)C)ccc1-2] | M^{+•} | 100 | 1.5 | 24.7 |

### Polyethylene

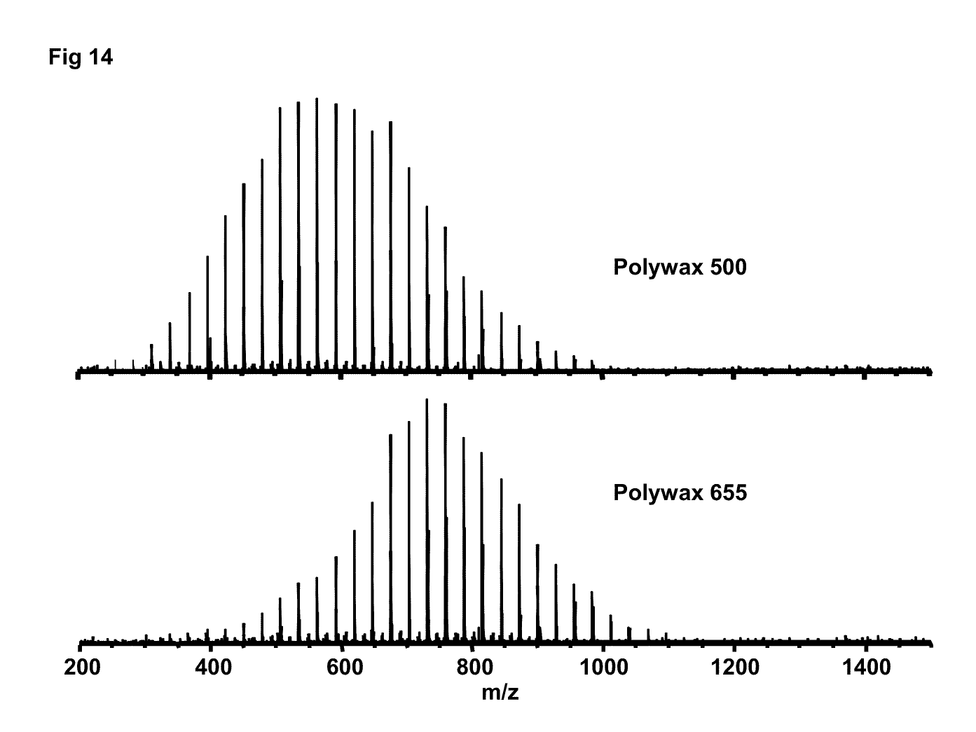

A potential application of the present technique is determination of polymer molecular weight and polydispersity. Results from analysis of two different polyethylenes (Polywax® 500 and Polywax® 655) by use of O₂ reagent/carrier gas with a linear ion trap and a 9.4 T FT-ICR mass spectrometer are summarized in Table 2. FIG. 14 presents representative FT-ICR mass spectra of the two samples, showing a peak distribution corresponding to hydride abstraction from each polymer chain. The FT-ICR mass spectral results generally give weight—(M_{W}) and number-average molecular weight (Mₙ) values somewhat higher than those obtained by GPC; the AP/LIAD-CI LIT MS values agree more closely with GPC data. The slightly higher values from AP/LIAD-CI FT-ICR MS could be due to time-of-flight mass discrimination that occurs as the ions are transmitted through the transfer quadrupole to the ICR cell. The time-of-flight effect can be corrected by acquisition of several mass spectra with incremental transfer period and the results superimposed on the same m/z axis. However, high resolution mass spectrometry enables identification of the polymer repeating units, thus complementing the GPC data.

Table 2 shows molecular weight distribution parameters for various polyethylene samples from AP/LIAD-CI MS with O₂ carrier/reagent gas, from two different mass spectrometers and gel permeation chromatography (GPC). Number-average molecular weight, Mₙ=ΣMᵢNᵢ/ΣNᵢ; weight-average molecular weight, M_{w}=ΣMᵢ²Nᵢ/ΣMᵢNᵢ, in which Mᵢ and Nᵢ are mass and mass spectral peak height for the ith component; and polydispersity, Q=M_{w}/Mₙ, are reported for each analysis technique.

TABLE 2

| | | | | AP/LIAD-CI | | | | | |
|---|---|---|---|---|---|---|---|---|---|
| | GPC | | | LIT MS | | | FT ICR MS | | |
| PE sample | Mn | Mw | Q | Mn | Mw | Q | Mn | Mw | Q |
| Polywax 500 | 500 | 540 | 1.08 | 543 | 565 | 1.04 | 600 | 630 | 1.05 |
| Polywax 655 | 655 | 707 | 1.08 | 656 | 672 | 1.03 | 751 | 774 | 1.03 |

### Complex Saturated Hydrocarbon Mixture

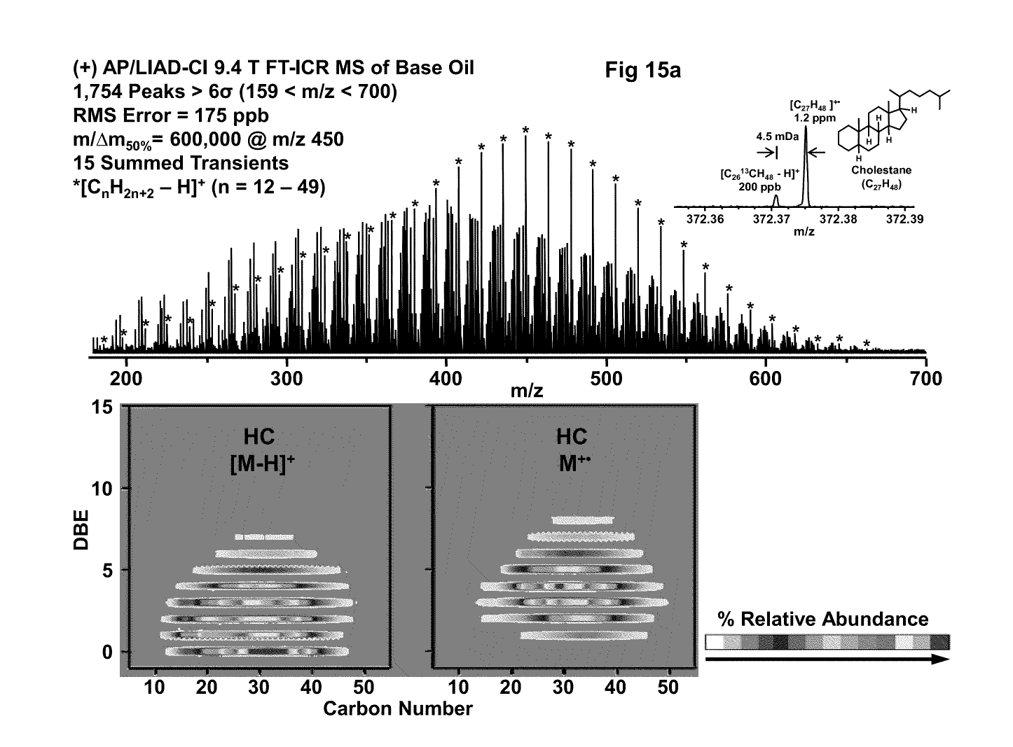

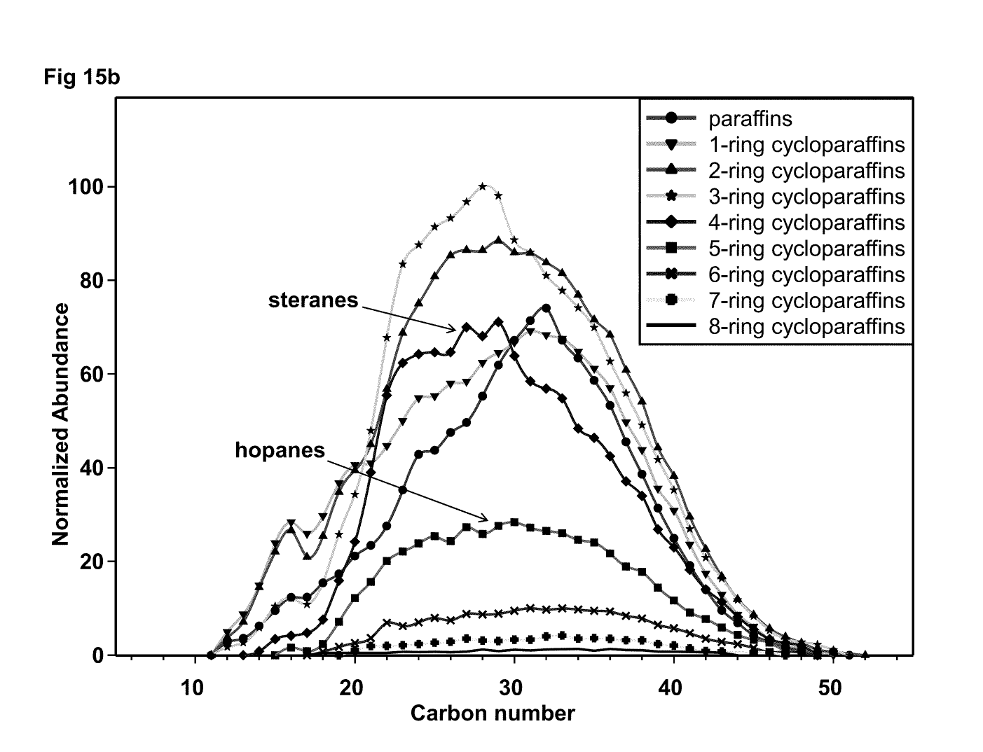

Perhaps the most important application of this method is determination of the saturated hydrocarbon composition of crude oil fractions and similar mixtures for petroleum biomarker identification. However, facile and reliable determination of the identity of the various sample components requires coupling to high resolution mass spectrometry to enable assignment of all observed ion signals. FIG. 15a shows results from analysis of a base oil sample by use of O₂ carrier/reagent gas with 9.4 T FT-ICR mass analysis. The mass spectrum contains more than 1,700 assigned peaks (each with magnitude higher than 6σ of baseline noise) from m/z 159-700, mass resolving power (m/Δm_{50%}, in which Δm_{50%} denotes the full mass spectral peak width at half-maximum peak height) of 600,000 at m/z 450, and 175 ppb rms error. The mass scale-expanded inset (top, right) highlights the requirement for ultrahigh resolution to separate species that differ in elemental composition by ¹³C versus CH (4.5 mDa difference in exact mass), for unambiguous assignment of elemental formulas for all of the peaks. The most abundant signals in the spectrum (highlighted by asterisks) correspond to a saturated hydrocarbon series (C₁₂-C₄₉). The relative abundance of each saturated hydrocarbon signal for each paraffin/cycloalkane series provides a reflection of the relative concentration of each species in the series within 4.0% RSD as demonstrated above for an equimolar straight-chain alkane mixture.

FIG. 15a (bottom) shows the isoabundance-contoured plot of the double bond equivalents (DBE=number of rings plus double bonds to carbon) vs. carbon number for species with elemental compositions, C_{c}Hₕ. The saturated hydrocarbon series (DBE=0) corresponding to alkanes has the highest relative abundance for ions generated by hydride abstraction (FIG. 15a, bottom left). The Figure also shows higher DBE series corresponding to cycloalkanes with increasing ring number, from 1 to 8 rings. At an HMC temperature of ˜250° C., cycloalkanes also generate radical cations, as shown by an isoabundance-contoured plot of DBE versus carbon number (FIG. 15a, bottom right). High-abundance species with carbon number, C₂₇ to C₃₀, and DBE=4 likely represent C₂₇-C₃₀ steranes, in agreement with FIMS, GC/EIMS, and GC×GC biomarker analysis of similar mixtures. The assignment of C₂₇ as cholestane, for example, is indicated by its expected hydrogen radical abstraction to yield [¹²C₂₆¹³C₁H₄₈—H]⁺ in the mass-scale expanded inset (FIG. 15a, top right). The presence of hydrogen radical abstraction signals for the C₂₈ and C₃₀ steranes was also confirmed in the spectrum. The hopane series biomarkers, containing 5 rings (i.e., DBE=5) are also apparent from the contour plot, which shows C₂₉-C₃₅ as the most abundant species of that type (FIG. 15a, bottom left). Their corresponding [M-H]⁺ signals are also confirmed in the spectrum and displayed in the left image.

Finally, FIG. 15b shows an alternative presentation of the data as trend lines of relative abundance vs. carbon number for each of the paraffin series, based on the number of rings (DBE) for each series. Because cycloparaffins generate M⁺. and [M-H]⁺, simultaneously (as noted above) their abundances were summed and then normalized (FIG. 15b). The data is in very good agreement with FIMS. The relative abundance for each paraffin series provides an estimate of its relative concentration for oil spill and oil contamination analyses. The sterane-to-hopane ratio has been used in petroleum exploration as a source facies indicator.

### Discussion

As can be seen from the examples presented above, AP/LIAD-CI MS with O₂ or N₂ carrier/reagent gas is presented as a novel approach for global hydrocarbons analysis. A carrier gas entrains the LIAD-vaporized analytes to the MS inlet, sweeps the region surrounding the inlet capillary free of atmospheric gases, and generates reagent ions for chemical ionization. With O₂ as carrier/reagent gas, [M-H]⁺ species dominate the mass spectrum for straight-chain and branched alkanes, whereas cycloalkanes produce [M-H]⁺ and M⁺. at relative abundance determined by the temperature of the heated metal capillary. N₂ carrier/reagent gas produces predominantly M⁺. for all alkane classes, but with significant fragmentation (at branching points) for branched alkanes to provide unique spectral fingerprints to distinguish constitutional isomers. Analysis of a straight-chain alkane equimolar mixture (C₂₁-C₄₀) with either O₂ or N₂ carrier/reagent gas provides nearly equal ionization efficiency for all sample components, auguring for quantitative analysis of such mixtures. These present results are comparable to previous investigations for analysis of saturated hydrocarbons by LIAD-CI MS with chemical ionization provided by a cyclopentadienyl cobalt radical cation or ligated water cluster of Mn⁺ (ClMn(H₂O)⁺), in vacuum. However, the present AP/LIAD-CI provides similar results at atmospheric pressure for much higher throughput (less than 3 minutes per sample, including sample preparation). Operation at atmospheric pressure also enables accumulation of ions prior to mass analysis, for higher signal magnitude. The technique is however not limited to the analysis of saturated hydrocarbon. It also enables analysis of the broad range of compound classes present in crude oil including: saturated, unsaturated nonpolar and polar heteroatom-containing hydrocarbons.

Combination of AP/LIAD CI (O₂ carrier/reagent gas) with FT-ICR MS for analysis of complex hydrocarbon mixtures provides ultrahigh mass resolution and accuracy to enable unique and reliable assignment of elemental compositions. Analysis of a base oil sample by the present approach identifies more than 1,700 elemental compositions (each derived from a mass spectral peak magnitude greater than 6σ of baseline rms noise) at mass resolving power of 600,000 at m/z 450 and rms mass error of 175 ppb from 15 time-domain acquisitions. The components consist of a paraffin (C₁₂-C₄₉) series, and series of cycloparaffins containing 1 to 8 rings, with relative abundances comparable to those produced by field ionization mass spectrometry. However, AP/LIAD-CI MS provides a more economical and high throughput alternative without the need to break vacuum for insertion of expensive FI/FD emitters (5-10 μM diameters) which are prone to break.

Although the present invention has been described in considerable detail with reference to certain preferred versions thereof, other versions are possible. Therefore, the spirit and scope of the appended claims should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C §112, sixth paragraph. In particular, the use of “step of” in the claims herein is not intended to invoke the provisions of 35 U.S.C §112, sixth paragraph.

What is claimed is:

1. A method comprising
depositing one or more analytes on a first surface of a foil membrane;
irradiating a second surface of the foil membrane that is opposed to the first surface with high energy laser pulses to create a shockwave to vaporize the one or more analytes deposited on the first surface;
transporting the vaporized analytes away from the foil membrane in a reagent gas stream;
subsequently transporting the vaporized analytes in the reagent gas stream through a corona discharge generated by an electrode;
subsequently transporting the vaporized analytes in the reagent gas stream through an inlet capillary of a mass spectrometer,
wherein each step of the method is conducted at atmospheric pressure.

2. The method according to claim 1, wherein the shockwave has an energy density greater than or equal to 0.7×10⁸ W/cm².

3. The method according to claim 1, wherein the method is conducted at a pressure in a range of from 720 to 800 Torr.

4. The method according to claim 1, wherein the method is conducted at a pressure of about 760 Torr.

5. The method according to claim 1, wherein the reagent gas stream comprises one selected from the group consisting of oxygen, nitrogen and combinations thereof.

6. The method according to claim 1, wherein the corona discharge is produced by a tungsten electrode placed orthogonally with respect to the mass spectrometer inlet capillary.

7. The method according to claim 6, wherein the tungsten electrode comprises a needle that is positioned at a distance in a range of from 2 to 5 mm with respect to the external surface of the mass spectrometer inlet capillary.

8. The method according to claim 6, wherein the tungsten electrode comprises a needle that is positioned at an angle with respect to the mass spectrometer inlet capillary of from 30 to 120 degrees.

9. The method according to claim 6, wherein the tungsten electrode comprises a needle operating at a needle voltage of from 2 to 5 kV.

10. The method according to claim 1, wherein transporting the vaporized analytes through the corona discharge-generated reagent ions initiate chemical ionization of analytes by one selected from the group consisting of hydride abstraction, charge exchange, proton transfer, and combinations thereof.

11. A system comprising a foil membrane, having a first surface suitable for depositing one or more analytes, and a second surface opposed to the first surface, the second surface being disposed toward a laser source capable of generating laser pulses to irradiate the second surface and to create a shockwave to vaporize the one or more analytes deposited on the first surface; a reagent gas inlet stream positioned relative to the foil membrane to enable transport of the vaporized analytes away from the foil membrane through a corona discharge generated by an electrode and toward an inlet capillary of a mass spectrometer.

12. The system according to claim 11, wherein the shockwave has an energy density greater than or equal to 0.7×10⁸ W/cm².

13. The system according to claim 11, wherein the system is operable at a pressure in a range of from 720 to 800 Torr.

14. The system according to claim 11, wherein the system is operable at a pressure of about 760 Torr.

15. The system according to claim 11, further comprising a tungsten electrode placed orthogonally with respect to the mass spectrometer inlet capillary, wherein the corona discharge is produced by the tungsten electrode.

16. The system according to claim 15, wherein the tungsten electrode comprises a needle that is positioned at a distance in a range of from 2 to 5 mm with respect to the external surface of the mass spectrometer inlet capillary.

17. The system according to claim 15, wherein the tungsten electrode comprises a needle that is positioned at an angle with respect to the mass spectrometer inlet capillary of from 30 to 120 degrees.

18. The system according to claim 15, wherein the tungsten electrode comprises a needle operating at a needle voltage of from 2 to 5 kV.

19. A device comprising:
a conical member comprising an outlet positioned about 5 mm from an inlet of a mass spectrometer inlet capillary;
a tungsten electrode positioned between the conical member and the inlet of the mass spectrometer inlet capillary;
a foil membrane disposed within the conical member, the foil membrane having a first surface, and a second surface opposed to the first surface;
a laser directing laser pulses at the second surface of the foil membrane to create a shockwave to vaporize one or more analytes deposited on the first surface;
a reagent gas inlet stream positioned relative to the foil membrane to pass a reagent gas across the foil member to transport vaporized analytes:
away from the foil membrane,
through the outlet of the conical member,
through a corona discharge generated by the tungsten electrode, and
into the inlet capillary of the mass spectrometer.

20. The device according to claim 19, wherein the shockwave has an energy density greater than or equal to 0.7×10⁸ W/cm².
